(19) United States
(12) Patent Application Publication
(10) Pub. No.: US 2022/0317349 A1
(43) Pub. Date: Oct. 6, 2022

(54) Mode Equalization Filter

(71) Applicant: Nippon Telegraph and Telephone Corporation, Tokyo (JP)

(72) Inventors: Hirotaka Ono, Musashino-shi, Tokyo (JP); Takayuki Mizuno, Musashino-shi, Tokyo (JP); Koki Shibahara, Musashino-shi, Tokyo (JP); Yutaka Miyamoto, Musashino-shi, Tokyo (JP)

(21) Appl. No.: 17/630,756

(22) PCT Filed: Aug. 14, 2019
(86) PCT No.: PCT/JP2019/031940

§ 371 Date: Jan. 27, 2022

(51) Int. Cl. G02B 5/20; G02B 6/26; F21V 8/00; G02B 6/02; G02B 6/028; H04B 10/2581

(52) U.S. Cl. CPC G02B 5/205; G02B 6/264; G02B 6/002; G02B 6/02047; G02B 6/0288; H04B 10/2581

(57) ABSTRACT

A mode equalization filter for reducing a difference in optical power between modes of signal light propagating inside FMFs of an MDM optical transmission scheme includes an FMF on the input side, a collimating lens, an ND filter, a condensing lens, and an FMF on the output side. The ND filter includes partial ND filters combined each other and having main surfaces placed in parallel to each other, a ring portion having a low transmittance is provided in a part of the partial ND filter, and a ring portion having a low transmittance is also provided in a part of the partial ND filter. When the ring portions have different aspects, and the partial ND filters are adjusted and set to be slidable in directions of axes, respectively, the partial ND filters have a property that the transmittance of each mode of the signal light differs and can obtain a function of a variable mode equalization filter.

### TECHNICAL FIELD

The present invention relates to a mode equalization filter that reduces a transmission loss difference between modes in a multimode optical fiber.

### BACKGROUND ART

In recent years, as the speed and capacity of communication services have increased, traffic transmitted by a trunk optical transmission system has increased dramatically. In order to cope with this increase in traffic in a trunk system, technical examination for dramatically increasing the transmission capacity of an optical transmission system is underway. Various transmission schemes are known, but recently, among them, technological development related to mode division multiplexing (hereinafter referred to as “MDM”) optical transmission is progressing rapidly.

It is known that, with this MDM optical transmission scheme, it is possible to superimpose different signals for a plurality of different modes of an optical signal, and to transmit the superimposed signals over a long distance. Further, in an MDM optical transmission scheme, even when mode conversion occurs when an optical signal propagates inside an optical fiber, an original signal is maintained, such that signals of a plurality of different modes can be identified and received through signal processing of a receiver. A multiple-input and multiple-output (MIMO) technology is known as an example of such signal processing, and related art thereof is disclosed in NPL 1 below.

In the above-described MDM optical transmission scheme, a multimode optical fiber used for transmission of an optical signal is designed such that only a predetermined mode of the optical signal is allowed to propagate. General-purpose examples include Few Mode Fiber (hereinafter referred to as “FMF”).

Generally, because a transmission loss with respect to a transmission distance of an optical signal propagating inside an FMF differs depending on a mode of the optical signal, such an event is called a “mode-dependent loss”. Further, in MDM optical transmission, an optical amplifier used is an optical amplifier capable of optically amplifying a mode that is the same as a mode allowed to propagate in FMF or a mode higher than the mode, and a gain value differs for each mode.

Thus, when an optical signal is transmitted over a long distance using a long-distance MDM optical transmission scheme, a difference in an optical power between modes of the optical signal increases as a transmission distance increases. Further, when the optical power is optically amplified, a difference in optical power between the modes of the optical signal increases. As a result, there is a problem that transmission characteristics of the optical signal vary between the modes and a transmission distance of the optical signal is limited. Such a problem also corresponds to a technology disclosed in NPL 1. Because the optical signal is substantially same as signal light, the optical signal will be hereinafter referred to as “signal light”.

### CITATION LIST

### Non Patent Literature

NPL 1: K. Shibahara et al., “Dense SDM (12-core×3-mode) transmission over 527 km with 33.2-ns mode-dispersion employing lower-complexity parallel MIMO frequency-domain equalization”, Journal of Lightwave Technology, January 2016, vol. 34, No. 1, pp. 196-204

### SUMMARY OF THE INVENTION

The present invention has been made to solve the above problems, and an object of the present invention is to provide a mode equalization filter for reducing a difference in optical power between modes of signal light propagating inside an FMF. The object is achieved by adopting the following configuration. As a result, a problem that a transmission distance of the signal light is limited due to a difference in optical power between propagation modes is solved.

A mode equalization filter according to an aspect of the present invention is a mode equalization filter for reducing a difference in light intensity between a plurality of modes of signal light propagating through a core of an FMF, the mode equalization filter including: a collimating lens configured to collimate the signal light emitted from the FMF on the input side; a neutral density filter (Neutral Density: hereinafter referred to as “ND”) provided with ring portions having a low transmittance through which the signal light collimated by the collimating lens passes; and a condensing lens configured to condense the signal light that has passed through the ring portion and has been transmitted through the ND filter onto the FMF on the output side, wherein the ring is provided in a part of a main surface of the ND filter on the signal light input side, and the ND filter is placed such that, when the signal light is transmitted, a part of the signal light collimated by the collimating lens is superimposed on the ring portion.

### BRIEF DESCRIPTION OF DRAWINGS

FIG. 1 is a perspective view schematically illustrating a basic configuration of a mode equalization filter according to a first embodiment of the present invention.

FIG. 2 is an optical power distribution diagram in a core cross section in the case of a 6-LP mode (10 modes) in which light propagates through FMFs included in the mode equalization filter illustrated in FIG. 1. (a) to (j) correspond to modes of LP01, LP11o, LP11e, LP21o, LP21e, LP02, LP31o, LP31e, LP12o, and LP12e, respectively.

FIG. 3 is an optical power distribution diagram in a core cross section showing a state of degeneration between the LP₃₁ₒ mode and the LP₃₁ₑ mode illustrated in FIGS. 2. (a) to 2(c) correspond to an odd mode LP₃₁ₒ, an even mode LP₃₁ₑ, and a degeneration mode LP₃₁ in which the odd mode and the even mode are degenerated, respectively.

### DESCRIPTION OF EMBODIMENTS

A mode equalization filter according to an embodiment of the present invention will be described in detail below with reference to the drawings.

### First Embodiment

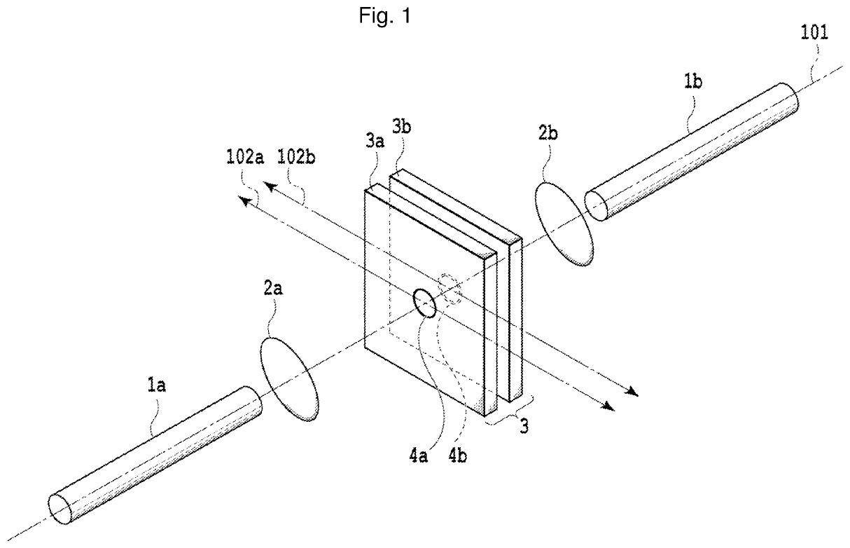

FIG. 1 is a perspective view schematically illustrating a basic configuration of a mode equalization filter according to a first embodiment of the present invention.

Referring to FIG. 1, the mode equalization filter according to the first embodiment includes components for reducing a difference in light intensity between a plurality of modes of signal light propagating through a core of an FMF of an MDM optical transmission scheme. The components are an FMF 1a on the input side, a collimating lens 2a, an ND filter 3, a condensing lens 2b, and an FMF 1b on the output side.

Among the components, the ND filter 3 includes a combination of a pair of partial ND filters 3a and 3b of which main surfaces are placed parallel to each other. The partial ND filters 3a and 3b have a flat plate shape, and are placed such that a plane normal of the main surfaces thereof is parallel to an optical axis 101. Further, a ring portion 4a having a low transmittance is provided on a part of the main surface of the partial ND filter 3a on the signal light input side. Further, a ring portion 4b having a low transmittance is provided on a part of the main surface of the partial ND filter 3b on the signal light input side.

That is, in the ND filter 3, when the signal light collimated by the collimating lens 2a is transmitted, the signal light passes through the ring portion 4a of the partial ND filter 3a, and then, the intensity of the signal light weakens, and the signal light is transmitted through the partial ND filter 3a. Thereafter, in also the partial ND filter 3b, after the signal light transmitted through the partial ND filter 3a passes through the ring portion 4b, the intensity of the signal light is weakened, and the signal light is transmitted through the partial ND filter 3b. The partial ND filters 3a and 3b are placed such that, when the signal light is transmitted, a part of the signal light collimated by the collimating lens 2a is superimposed on the ring portions 4a and 4b.

That is, the signal light transmitted through the collimating lens 2a is arranged to partially pass through the ring portions 4a and 4b having a low transmittance provided on the partial ND filters 3a and 3b. Here, of the signal light transmitted through the collimating lens 2a, a part of a cross section that is parallel to planes of the partial ND filters 3a and 3b and a part of the ring portions 4a and 4b having a low transmittance provided on the partial ND filters 3a and 3b are superimposed. The ring portions 4a and 4b in the partial ND filters 3a and 3b function as variable transmission portions.

Briefly describing a functional configuration of each part, the FMF 1a is placed on the signal light input side, and the signal light is incident on the FMF 1a. The collimating lens 2a is placed such that a lens surface of the collimating lends 2a faces an end portion of the FMF 1a, the signal light emitted from the end portion of the FMF 1a is transmitted through the collimating lens 2a and collimated (converted to parallel rays). The ND filter 3 transmits the signal light collimated by the collimating lens 2a such that a difference in optical power between the modes is reduced using a function of a variable mode equalization filter described below. The condensing lens 2b concentrates the signal light transmitted through the ND filter 3 on the FMF 1b on the output side. The FMF 1b propagates the signal light condensed by the condensing lens 2b and emits the signal light.

According to the detailed description of the functional configuration of each part, the ND filter 3 includes a pair of partial ND filters 3a and 3b, and ring portions 4a and 4b are provided in a part of a main surface on the signal light input side. Thus, in the ND filter 3, when the signal light collimated by the collimating lens 2a is transmitted, the signal light passes through the ring portion 4a of the partial ND filter 3a and is then transmitted through the partial ND filter 3a. Thereafter, in the partial ND filter 3b, the signal light transmitted through the partial ND filter 3a passes through the ring portion 4b and is then transmitted through the partial ND filter 3b.

Here, optical power of the signal light passing through the ring portions 4a and 4b in the signal light is lower than an optical power of the signal light passing through a portion of the partial ND filters 3a and 3b in which the ring portions 4a and 4b are not provided. In other words, the intensity of the signal light is lower when the signal light passes through the ring portion 4a and is transmitted through the partial ND filter 3a than when the signal light is transmitted through the partial ND filter 3a without passing through the ring portion 4a. The relationship of the intensity of the signal light is the same between a case in which the signal light passes through the ring portion 4b and is transmitted through the partial ND filter 3b and a case in which the signal light is transmitted through the partial ND filter 3b without passing through the ring portion 4b.

The condensing lens 2b is placed such that one lens surface thereof faces the partial ND filter 3b and the ring portion 4b, and the other lens surface faces an end portion of the FMF 1b. The condensing lens 2b condenses the signal light passing and being transmitted through the ring portions 4a and 4b and the partial ND filters onto the FMF 1b on the output side. That is, the condensing lens 2b condenses the signal light in a direction parallel to the optical axis 101 in the signal light transmitted through the partial ND filters 3a and 3b, including the signal light passing through the ring portions 4a and 4b of the partial ND filters 3a and 3b, on an end portion of the FMF 1b. The FMF 1b propagates the signal light condensed by the condensing lens 2b and emits the signal light.

The above-described partial ND filters 3a and 3b are designed to reduce a transmittance of a part of a collimated light intensity distribution by providing the ring portions 4a and 4b having a low transmittance on respective transparent glass substrates. Further, the respective partial ND filters 3a and 3b can be slid in one direction on planes perpendicular to the optical axis 101 of the signal light such that a transmittance can be set to be different for each mode with respect to mode light having a different collimated light intensity distribution.

Specifically, the partial ND filter 3a is slidable with respect to an axis 102a perpendicular to the optical axis 101, and the partial ND filter 3b is slidable with respect to an axis 102b parallel to the axis 102a perpendicular to the optical axis 101. Thus, the partial ND filters 3a and 3b may be provided with a slide mechanism and may be moved in directions of the axes 102a and 102b, respectively. Well-known techniques can be applied for such structures.

The slide mechanism is based on the fact that the partial ND filters 3a and 3b are provided to, for example, in guides parallel to the axes 102a and 102b, and has a structure in which the partial ND filters 3a and 3b are pressed by a spring from one side and by a micrometer head from the other side. It is preferable to configure a mechanism that changes sliding amounts of the partial ND filters 3a and 3b by inserting and removing a micrometer head. However, for the slide mechanism, any mechanism can be applied as long as the mechanism does not block collimated signal light. In the slide mechanism, a negative value of the sliding amount of the partial ND filter 3b indicates that the partial ND filter 3b is shifted in a direction opposite to the partial ND filter 3a.

In the mode equalization filter according to the first embodiment, when an inner radius, outer radius, transmittance, and shift amount of the individual ring portions 4a and 4b provided in the partial ND filters 3a and 3b are set to predetermined values, a predetermined transmission loss is obtained for each propagation mode of the signal light. This makes it possible to obtain an effect of reducing a degree of transmission loss different for each propagation mode of the signal light. Further, when sliding of the partial ND filters 3a and 3b is appropriately adjusted, a function of the variable mode equalization filter can be obtained. Thereby, the partial ND filters 3a and 3b can have a property that a transmittance of the signal light for each mode differs depending on the inner radius, outer radius, transmittance, and shift amount of the ring portions 4a and 4b.

Incidentally, components included in the mode equalization filter according to the first embodiment are placed along the optical axis 101 in a traveling direction of the signal light. These components are the FMFs 1a and 1b, the collimating lens 2a, the condensing lens 2b, and the ND filter 3 (the partial ND filters 3a and 3b provided with the ring portions 4a and 4b). The collimating lens 2a and the condensing lens 2b are placed between the FMFs 1a and 1b, and the partial ND filters 3a and 3b provided with the ring portions 4a and 4b are placed between the collimating lens 2a and the condensing lens 2b.

The FMFs 1a and 1b are placed such that main axes of the cores thereof match the optical axis 101 of the signal light. The FMFs 1a and 1b are composed of the core and a cladding having a refractive index lower than that of the core, and the signal light propagates inside the core. Here, an optical fiber in a 6-LP mode having six propagation modes to the FMFs 1a and 1b is used. Thus, the number of propagation modes in which the signal light propagates inside the cores of the FMFs 1a and 1b is six (total ten modes when even modes and odd modes are distinguished).

That is, the signal light input from one end portion of the FMFs 1a and 1b propagates in the six propagation modes and is output from the other end portion while these propagation modes are being maintained. However, the 6-LP mode disclosed herein is merely an example, and the number of modes is not limited thereto and various lenses, the ND filters 3, and the like can be applied even when different aspects are adopted.

Further, materials of the partial ND filters 3a and 3b are not particularly limited as long as the optical power of the signal light does not decrease when the signal light passes through and is transmitted. For example, a case in which quartz glass (SiO₂) is used may be exemplified, and in addition, a material that does not reduce the optical power when the signal light passes through and is transmitted can be arbitrarily used.

The ring portions 4a and 4b are preferably provided flatly and smoothly on the partial ND filters 3a and 3b. For example, the ring portions 4a and 4b can be provided on the partial ND filters 3a and 3b by applying a known thin film manufacturing method. Further, a shape of the ring portions 4a and 4b is not particularly limited as long as a condition that the ring portions 4a and 4b are superimposed on a part of the cross section of the collimated signal light, and the optical power after the signal light has passed through this part is lower than that before the signal light passes through the part is satisfied. For example, any shape may be adopted as the shape of the ring portions 4a and 4b as long as the shape is a ring form similar to a general-purpose circular ring, elliptical ring, polygonal ring, or any other shape.

The number of partial ND filters constituting the ND filter 3 may three or more, but considering the labor and cost of the slide adjustment setting described above, it is not preferable to increase the number more than necessary.

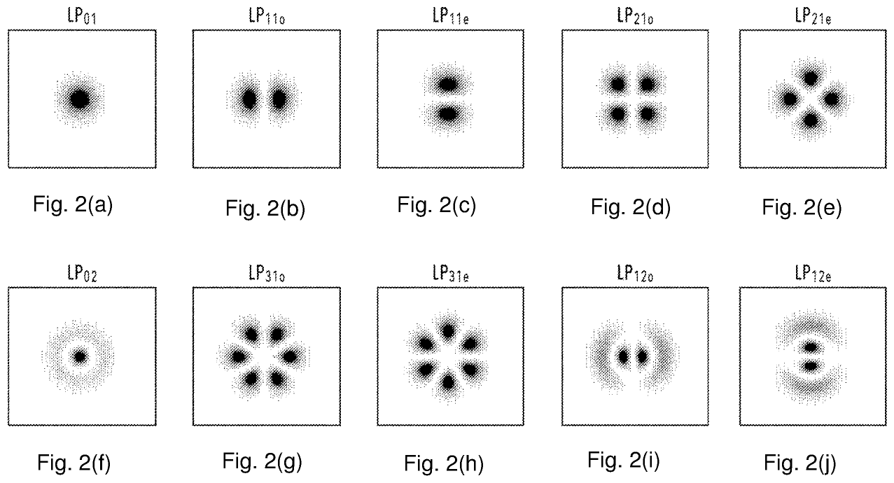

FIG. 2 is an optical power distribution diagram in a core cross section in the case of the 6-LP mode (10 modes) in which light propagates through the FMFs 1a and 1b included in the mode equalization filter described above. FIGS. 2(a) to 2(j) are optical power distribution diagrams corresponding to the modes of LP₀₁, LP₁₁ₒ, LP₁₁ₑ, LP₂₁ₒ, LP₂₁ₑ, LP₀₂, LP₃₁ₒ, LP₃₁ₑ, LP₁₂ₒ, and LP₁₂ₑ.

However, FIG. 2 shows that the darker the black color, the greater the optical power, and the closer to white (paper surface color) from black, the smaller the optical power. Here, numbers in the subscript of LP indicate an aspect of the propagating mode. o indicates an odd mode, and e indicates an even mode.

Referring to respective figures in FIG. 2, LP₁₁ₒ mode and LP₁₁ₑ mode, LP₂₁ₒ mode and LP₂₁ₑ mode, LP₃₁ₒ mode and LP₃₁ₑ mode, and LP₁₂ₒ mode and LP₁₂ₑ mode are subjected to mode conversion during propagation in the 6-LP mode. As a result of this mode conversion, the odd modes o and the even modes e are degenerated into degeneration modes LP₁₁, LP₂₁, LP₃₁, and LP₁₂.

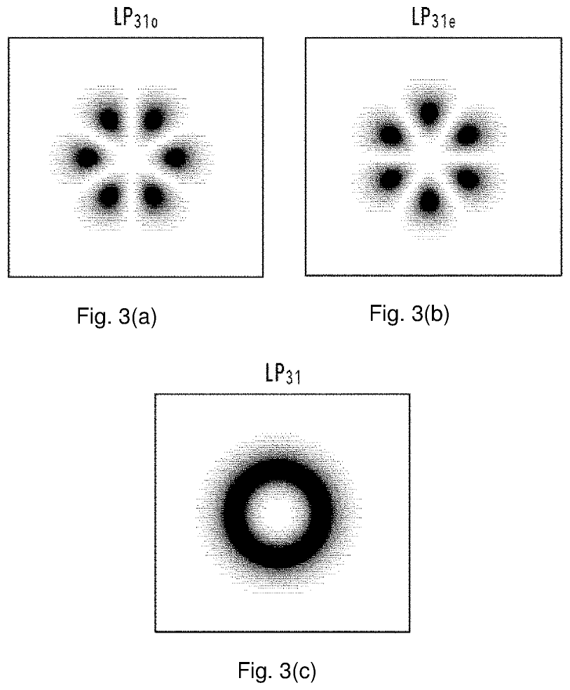

FIG. 3 is an optical power distribution diagram in a core cross section showing a state of degeneration between the LP₃₁ₒ mode and the LP₃₁ₑ mode illustrated in FIG. 2. FIGS. 3(a) to 3(c) are optical power distribution diagrams corresponding to the odd mode LP₃₁ₒ, the even mode LP₃₁ₑ, and the degeneration mode LP₃₁ in which the odd mode LP₃₁ₒ and the even mode LP₃₁ₑ have been degenerated.

Referring to FIG. 3, in both the odd mode LP₃₁ₒ in FIG. 3(a) and the even mode LP₃₁ₑ in FIG. 3(b), the optical power distribution has a discrete spot shape. On the other hand, in the degeneration mode LP₃₁ of FIG. 3(c) in which the odd mode and the even mode have been degenerated, it can be seen that the optical power distribution is a connected ring shape. Further, in the LP₂₁ mode and the LP₀₂ mode, and the LP₃₁ mode and the LP₁₂ mode, values of propagation constants are very close to each other. Thus, mode conversion occurs frequently during propagation in the FMFs 1a and 1b, and it becomes impossible to distinguish between the two modes in terms of optical characteristics. Thus, in evaluation of optical characteristics such as a mode-dependent loss and a gain of the optical amplifier, it is effective to treat the modes as LP₂₁ mode+LP₀₂ mode and LP₃₁ mode+LP₁₂ mode, respectively.

The mode equalization filter according to the first embodiment has a property that the transmittance of the signal light of the partial ND filters 3a and 3b forming the ND filter 3 for each mode differs depending on the aspect of the ring portions 4a and 4b, as described above. This property is the same in a mode equalization filter according to JP 2018-136150 previously proposed by the present inventor and the like.

In the mode equalization filter of the first embodiment, an inner radius, outer radius, transmittance, and shift amount of the ring portion 4a of the partial ND filter 3a were set to 426 μm, 750 μm, 0.00148, and 17.8 μm, respectively. Further, an inner radius, outer radius, transmittance, and shift amount of the ring portion 4b of the partial ND filter 3b were set to 22 μm, 724 μm, 0.11, and −1.98 μm, respectively.

In the mode equalization filter of the first embodiment, it is possible to set a predetermined transmission loss for each propagation mode of the signal light by forming the ring portions 4a and 4b in different aspects. Specifically, a case can be exemplified in which transmission losses of L_{P01} mode, LP₁₁ mode, LP₂₁ mode+LP₀₂ mode, and LP₃₁ mode+LP₁₂ mode are set to 7.0 dB, 4.6 dB, 3.1 dB, and 2.3 dB, respectively.

Further, when the partial ND filters 3a and 3b are moved in directions of the axes 102a and 102b and adjusted and set in addition to the ring portions 4a and 4b being formed in the different aspects, the function of the variable mode equalization filter can be obtained. Using the function of this variable mode equalization filter, it is possible to reduce an inter-mode gain difference (mode-dependent loss) caused by the FMFs 1a and 1b and the optical amplifier.

Specifically, an inter-mode gain difference between the LP₀₁ mode and the LP₁₁ mode can be reduced from 2.6 dB to 0.2 dB, and an inter-mode gain difference between the LP₀₁ mode and the LP₂₁ mode+LP₀₂ mode can be reduced from 4.1 dB to 0.2 dB. Further, an inter-mode gain difference between the LP₀₁ mode and the LP₃₁ mode+LP₁₂ mode can be reduced from 5.1 dB to 0.4 dB, and an inter-mode gain difference between the LP₁₁ mode and the LP₂₁ mode+LP₀₂ mode can be reduced from 1.5 dB to 0.0 dB. In addition, an inter-mode gain difference between the LP₁₁ mode and the LP₃₁ mode+LP₁₂ mode can be reduced from 2.5 dB to 0.2 dB, and an inter-mode gain difference between the LP₂₁ mode+LP₀₂ mode and the LP₃₁ mode+LP₁₂ mode can be reduced from 1.0 dB to 0.2 dB.

The mode equalization filter according to the first embodiment described above includes the ring portions 4a and 4b in different aspects, the ring portions 4a and 4b serving as variable transmission portions having a low transmittance through which the signal light passes in parts of the partial ND filters 3a and 3b forming the ND filter 3. The function of the variable mode equalization filter is obtained by appropriately sliding the partial ND filters 3a and 3b for adjustment and setting. Thereby, it is possible to reduce an optical power difference between the modes of the signal light propagating inside the FMFs 1a and 1b of the MDM optical transmission scheme and the mode-dependent loss. As a result, a problem that a transmission distance of the signal light is limited due to the difference in optical power between the propagation modes is solved.

1. A mode equalization filter configured to reduce a difference in light intensity between a plurality of modes of signal light propagating through a core of a few mode fibers, the mode equalization filter comprising:
a collimating lens configured to collimate signal light emitted from the few mode fibers on an input side;
a neutral density filter provided with a plurality of ring portions through which the signal light collimated by the collimating lens passes, the ring portions having a low transmittance; and
a condensing lens configured to condense the signal light that has passed through the plurality of ring portions and has been transmitted through the neutral density filter onto the few mode fiber on an output side,
wherein the plurality of ring portions are provided in a part of a main surface of the neutral density filter on the input side of the signal light, and
the neutral density filter is placed such that, when the signal light is transmitted, a part of the signal light collimated by the collimating lens is superimposed on the ring portion.

2. The mode equalization filter according to claim 1, wherein the neutral density filter includes a plurality of partial neutral density filters combined each other, the plurality of partial neutral density filters having main surfaces placed in parallel to each other, and having a transmittance different for an individual mode of the signal light depending on the ring portions individually provided, and.

3. The mode equalization filter according to claim 2, wherein intensity of the signal light is lower when the signal light passes through the ring portion and is transmitted through the partial neutral density filter than when the signal light is transmitted through the partial neutral density filter without passing through the ring portion.

4. The mode equalization filter according to claim 2, wherein the partial neutral density filter includes the ring portion provided in a transparent substrate placed between the collimating lens and the condensing lens, and is designed so as to reduce the transmittance for a part of a collimated light intensity distribution.

5. The mode equalization filter according to claim 4, wherein the partial neutral density filter is slidable at least in one direction in a plane perpendicular to an optical axis of the signal light to set the transmittance to be different for an individual mode with respect to mode light having a different collimated light intensity distribution.

6. The mode equalization filter according to claim 3, wherein the partial neutral density filter includes the ring portion provided in a transparent substrate placed between the collimating lens and the condensing lens, and is designed so as to reduce the transmittance for a part of a collimated light intensity distribution.
